(19) United States
(12) Patent Application Publication
(10) Pub. No.: US 2025/0063346 A1
(43) Pub. Date: Feb. 20, 2025

(54) DEVICE FOR PERFORMING QUANTUM-ENCRYPTED CALL AND OPERATION METHOD OF ELECTRONIC DEVICE

(71) Applicant: Samsung Electronics Co., Ltd., Suwon-si (KR)

(72) Inventors: Hyunjae KIM, Suwon-si (KR); Yongtae KIM, Suwon-si (KR); Taewon DO, Suwon-si (KR); Hyonmyong CHO, Suwon-si (KR)

(21) Appl. No.: 18/819,426

(22) Filed: Aug. 29, 2024

Related U.S. Application Data
(63) Continuation of application No. PCT/KR2024/012052, filed on Aug. 13, 2024.

(30) Foreign Application Priority Data
Aug. 18, 2023 (KR) 10-2023-0108518
Nov. 28, 2023 (KR) 10-2023-0168138

(51) Int. Cl. H04W 12/033; H04L 5/00; H04W 12/043; H04W 80/06

(52) U.S. Cl. CPC H04W 12/033; H04L 5/0053; H04W 12/043; H04W 80/06

(57) ABSTRACT

In an electronic device and an operation method of the electronic device according to an embodiment, the electronic device may include: a communication circuit, an application processor including at least one processor comprising processing circuitry, and a communication processor including at least one processor comprising processing circuitry, wherein at least one processor, individually and/or collectively, of the application processor is configured to: according to initiation of a call, receive, from a cellular network supporting a quantum encrypted call, identity information of a session of the quantum encrypted call and information indicating a key of the quantum encrypted call, determine a number of times of transmission of at least one packet for identifying whether an external electronic device to be connected via the session has the identity information of the session and/or the key, based on a status of a channel between the electronic device and the cellular network, control the electronic device to transmit the at least one packet to the external electronic device, based on the determined number of times of transmission, and based on the electronic device receiving, from the external electronic device, an acknowledgement packet indicating that the external electronic device has the identity information of the session and the key, perform the quantum encrypted call, based on the key.

### CROSS-REFERENCE TO RELATED APPLICATIONS

This application is a continuation of International Application No. PCT/KR2024/012052 designating the United States, filed on Aug. 13, 2024, in the Korean Intellectual Property Receiving Office and claiming priority to Korean Patent Application Nos. 10-2023-0108518, filed on Aug. 18, 2023, and 10-2023-0168138, filed on Nov. 28, 2023, in the Korean Intellectual Property Office, the disclosures of each of which are incorporated by reference herein in their entireties.

### BACKGROUND

### Field

The disclosure relates to an electronic device and an operation method of the electronic device and, for example, to a technology for performing a quantum-encrypted call.

### Description of Related Art

Various electronic devices, such as smartphones, tablet PCs, portable multimedia players (PMPs), personal digital assistants (PDAs), laptop PCs (laptop personal computers), and/or wearable devices are widely used.

An electronic device may be connected to a cellular network and perform cellular communication. The electronic device may provide various services to a user of the electronic device through cellular communication. For example, the electronic device may provide a voice call or video call service to the user through cellular communication.

For improvement of security of data exchanged during calls, various technologies are applied to the electronic device. For example, the electronic device may support quantum-encrypted calls using quantum passwords. A quantum-encrypted call may refer, for example, to a call of a scheme of encrypting or decrypting packets (or data) transmitted and/or received during the call using a quantum password. Such a quantum-encrypted call is implemented in a scheme of exchanging encrypted packets (or data) using quantum mechanical characteristics to make eavesdropping or interception difficult and is thus highly regarded in terms of security.

Electronic devices performing a quantum-encrypted call may exchange identity information of a session to be established for the electronic devices and a key to be used for encryption and/or decryption of data to be exchanged through the session. The quantum-encrypted call may be activated when the electronic devices to perform the quantum-encrypted call have the same identity information and key. The electronic devices may transmit and/or receive a packet for identifying possession of the same identity information and key, in a process of configuring a quantum-encrypted call (or a negotiation process).

In generating a packet for identifying possession of identity information of a session and a key, a session initiation protocol (SIP) and/or a session description protocol (SDP) of an Internet protocol (IP) multimedia subsystem (IMS) may not be used. A packet generated using the SIP and/or SDP may cause a problem in some electronic devices.

Electronic devices performing a quantum-encrypted call may generate a packet using a real-time protocol (RTP) rather than the SIP and/or SDP. A packet generated using the RTP may be transmitted through a user datagram protocol (UDP). When a packet is exchanged through the UDP, the integrity of transmission and/or reception of the packet may not be ensured. Therefore, the electronic devices may transmit the packet multiple times in order to increase the reception probability of the packet. However, repetition of packet transmission may increase the time taken to configure a quantum-encrypted call. According to an example, the greater the number of times of packet transmission, the greater the time taken to configure a quantum-encrypted call.

### SUMMARY

An electronic device according to an example embodiment may include: a communication circuit; an application processor comprising processing circuitry; a communication processor comprising processing circuitry, wherein at least one processor, comprising processing circuitry, of the application processor may individually and/or collectively, be configured to: according to initiation of a call, receive, from a cellular network supporting a quantum encrypted call, identity information of a session of the quantum encrypted call and information indicating a key of the quantum encrypted call; determine a number of times of transmission of at least one packet for identifying whether an external electronic device to be connected via the session has the identity information of the session and/or the key, based on a status of a channel between the cellular network and the electronic device; control the electronic device to transmit the at least one packet to the external electronic device, based on the determined number of times of transmission; based on the electronic device receiving, from the external electronic device, an acknowledgement packet indicating that the external electronic device has the identity information of the session and the key, perform the quantum encrypted call, based on the key.

A method of operating an electronic device according to an example embodiment may include: receiving, according to initiation of a call and from a cellular network supporting a quantum encrypted call, identity information of a session of the quantum encrypted call and information indicating a key of the quantum encrypted call; determining a number of times of transmission of at least one packet for identifying whether the external electronic device to be connected via the session has the identity information of the session and/or the key, based on a status of a channel between the cellular network and the electronic device; transmitting the at least one packet to the external electronic device, based on the determined number of times of transmission; based on the electronic device receiving, from the external electronic device, an acknowledgement packet indicating that the external electronic device has the identity information of the session and the key, performing the quantum encrypted call, based on the key.

By an electronic device and an operation method of the electronic device according to an example embodiment, the number of times of transmission of a packet for identifying whether an external electronic device has identification information of a session and/or a key may be determined based on a status of a channel between a cellular network and the electronic device. Therefore, the electronic device may properly configure the number of times of packet transmission, based on the status of the channel between the cellular network and the electronic device, thereby reducing the time taken to configure a quantum-encrypted call.

Effects which are acquirable by the disclosure are not limited to the effects described above, and other effects that have not been mentioned may be clearly understood by one skilled in the technical field to which the disclosure belongs, from the following description.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device according to various embodiments;

FIG. 2A is a block diagram illustrating an example configuration in which an electronic device performs a quantum-encrypted call with an external electronic device according to various embodiments;

FIG. 2B is a signal flow diagram illustrating an example in which an electronic device transmits and/or receives at least one packet for identifying whether an external electronic device has identity information of a session and/or a key of a quantum-encrypted call according to various embodiments;

FIG. 3 is a block diagram illustrating an example configuration of an electronic device according to various embodiments;

FIG. 4 is a block diagram illustrating an example configuration of an electronic device according to various embodiments;

FIG. 5 is a signal flow diagram illustrating an example in which an electronic device transmits and/or receives at least one packet for identifying whether an external electronic device has identity information of a session and/or a key of a quantum-encrypted call according to various embodiments;

FIG. 6 is a signal flow diagram illustrating an example in which an electronic device transmits and/or receives at least one packet for identifying whether an external electronic device has identity information of a session and/or a key of a quantum-encrypted call according to various embodiments;

FIG. 7A and FIG. 7B are diagrams illustrating an example in which an electronic device outputs information indicating activation of a quantum-encrypted call according to various embodiments; and

FIG. 8 is a flowchart illustrating an example method of operating an electronic device according to various embodiments.

### DETAILED DESCRIPTION

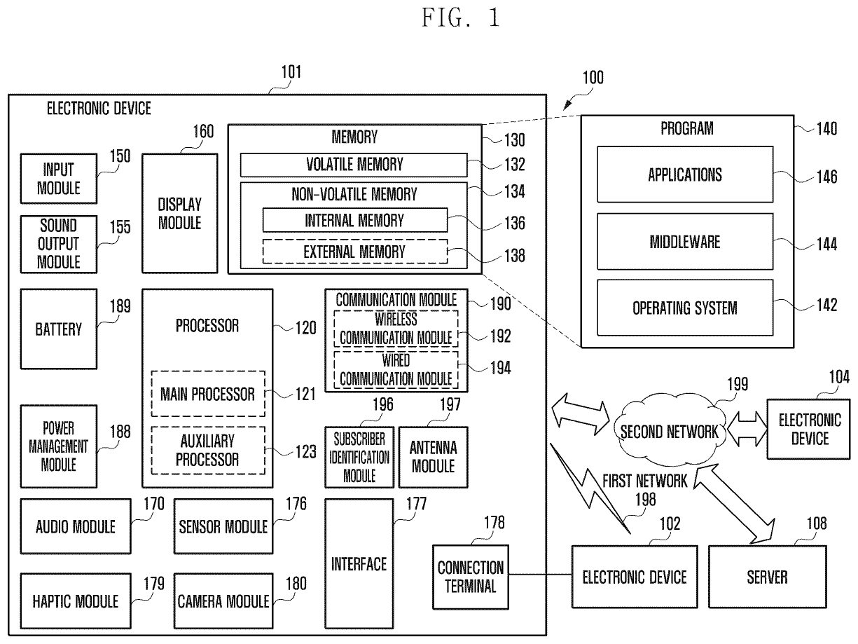

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In various embodiments, at least one (e.g., the display device 160 or the camera module 180) of the components may be omitted from the electronic device 101, or one or more other components may be added in the electronic device 101. In various embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

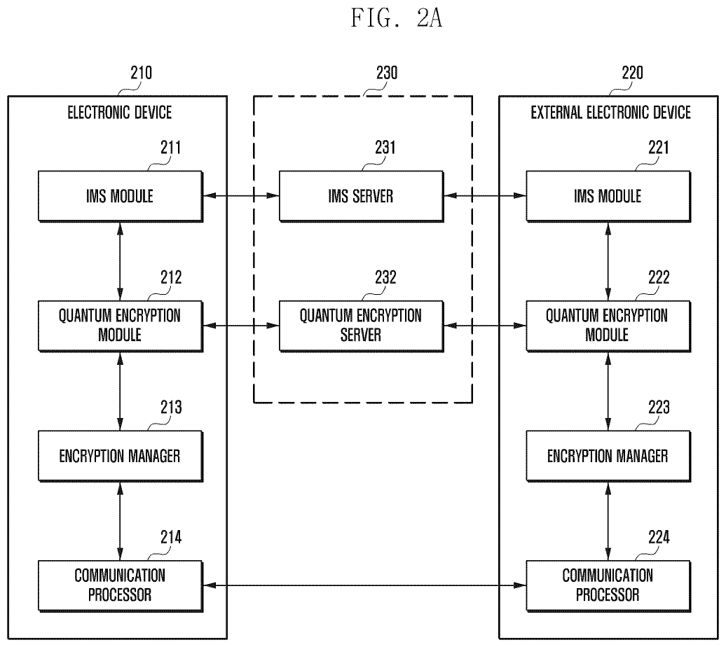

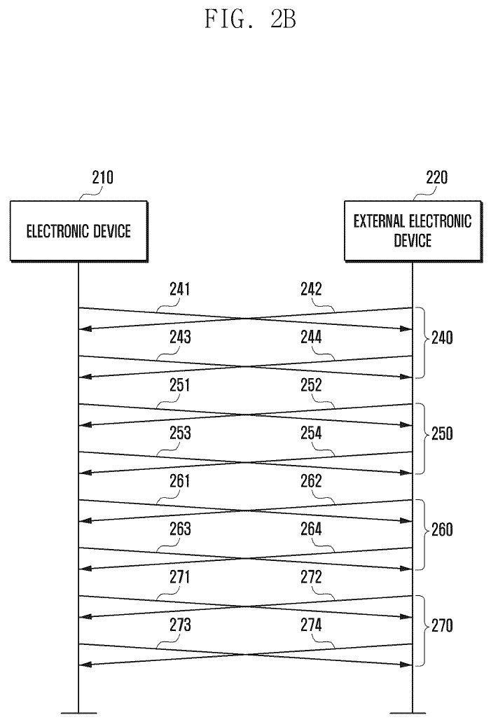

FIG. 2A is a block diagram illustrating an example configuration in which an electronic device performs an example quantum-encrypted call with an external electronic device according to various embodiments.

Referring to FIG. 2A, an electronic device 210 (e.g., the electronic device 101 in FIG. 1) and/or an external electronic device 220 (e.g., the electronic device 104 in FIG. 1) may support a quantum-encrypted call. A quantum-encrypted call may be a call of a scheme of encrypting or decrypting packets (or data) transmitted and/or received during the call using a quantum password. Such a quantum-encrypted call is implemented in a scheme of exchanging encrypted packets (or data) using quantum mechanical characteristics to make eavesdropping or interception difficult and is thus highly regarded in terms of security.

The electronic device 210 may include an IMS module (e.g., including various circuitry and/or executable program instructions) 211, a quantum encryption module (e.g., including various circuitry and/or executable program instructions) 212, an encryption manager (e.g., including various circuitry and/or executable program instructions) 213, and/or a communication processor (e.g., including processing circuitry) 214. An external electronic device 220 may include an IMS module (e.g., including various circuitry and/or executable program instructions) 221, a quantum encryption module (e.g., including various circuitry and/or executable program instructions) 222, an encryption manager (e.g., including various circuitry and/or executable program instructions) 223, and/or a communication processor (e.g., including processing circuitry) 224.

The IMS module 211 or 221 is an entity that performs origination and/or termination of a call, and may establish a session for a call using a session initiation protocol (SIP). The IMS module 211 or 221 may communicate with an IMS server 231 of a cellular network 230. The IMS server 231 may be a call-related server operated by an operator of the cellular network 230. The IMS server 231 may transfer a signal (e.g., a call occurrence notification signal) exchanged between the electronic device 210 and the external electronic device 220 (e.g., the electronic device 104 in FIG. 1) performing a call with the electronic device 210. According to an example, the IMS server 231 may receive a call request signal transmitted by the electronic device 210 originating a call, and transmit the call request signal to the external electronic device 220.

The quantum encryption module 212 or 222 may request and/or receive information required for a quantum-encrypted call from a quantum encryption server 232 of the cellular network 230. The information required for a quantum-encrypted call may include identity information of a session to be established between the electronic device 210 and the external electronic device 220, and a key that is able to be used for encryption of a packet (or data) to be transmitted and/or received through the session. According to an example, a key used for quantum encryption may include information of a polarizing filter to be used for encryption or decryption of data.

The quantum encryption server 232 is a server operated by an operator of the cellular network 230, and may store information required for a quantum-encrypted call. The quantum encryption server 232 may, when a signal requesting information required for a quantum-encrypted call is received from the electronic device 210 and/or the external electronic device 220, provide the information required for the quantum-encrypted call to the electronic device 210 and/or the external electronic device 220.

The quantum encryption module 212 or 222 may receive information required for a quantum-encrypted call from the quantum encryption server 232 and transmit the information required for the quantum-encrypted call to the encryption manager 213 or 223.

The encryption manager 213 or 223 may be an entity that encrypts or decrypts data transmitted and/or received through a session established between the electronic device 210 and the external electronic device 220. The encryption manager 213 or 223 may encrypt data to be transmitted through a session, based on a key, and transmit the encrypted data to the communication processor 214 or 224. The communication processor 214 or 224 may transmit encrypted data to the external electronic device 220 (or the communication processor 224 of the external electronic device 220).

The IMS module 211, the quantum encryption module 212, and/or the encryption manager 213 may be an entity implemented in a software and/or hardware type on an application processor (e.g., the processor 120 in FIG. 1) of the electronic device 210. The IMS module 221, the quantum encryption module 222, and/or the encryption manager 223 may be an entity implemented in a software and/or hardware type on an application processor (e.g., the processor 120 in FIG. 1) of the external electronic device 220.

The external electronic device 220 (or the communication processor 224 of the external electronic device 220 (e.g., the processor 120 in FIG. 1) may receive, through a session, encrypted data transmitted by the electronic device 210 and transmit the encrypted data to the encryption manager 223.

The encryption manager 223 may decrypt encrypted data, based on information related to a quantum-encrypted call. The decrypted data may be processed by an application processor (e.g., the processor 120 in FIG. 1) of the external electronic device 220 and then provided to a user in a voice and/or video type.

A quantum-encrypted call described above may be activated when the electronic device 210 and the external electronic device 220 performing the quantum-encrypted call have the same identity information of a session and the same key.

The quantum-encrypted call may not be activated when it is not identified that the electronic device 210 and the external electronic device 220 have the same identity information and the same key. The electronic device 210 and the external electronic device 220 may perform a procedure for identifying whether the electronic device and the external electronic device have the same identity information and the same key, before activating a quantum-encrypted call, and a more detailed example will be described with reference to FIG. 2B.

FIG. 2B is a signal flow diagram illustrating an example in which an electronic device transmits and/or receives at least one packet for identifying whether an external electronic device has identity information of a session and/or a key of a quantum-encrypted call according to various embodiments.

As described above with reference to FIG. 2A, an electronic device (e.g., the electronic device 210 in FIG. 2A) may perform a procedure for identifying whether an external electronic device (e.g., the external electronic device 220 in FIG. 2A) to perform a quantum-encrypted call together has identity information of a session to be established between the electronic device 210 and the external electronic device 220 and/or a key used for encryption of a packet (or data) exchanged through the session. The external electronic device 220 may also perform a procedure for identifying whether the electronic device 210 has identity information of a session to be established between the electronic device 210 and the external electronic device 220 and/or a key used for encryption of a packet (or data) exchanged through the session.

The procedure for identifying possession of identity information of a session to be established between the electronic device 210 and the external electronic device 220 and/or a key used for encryption of a packet (or data) exchanged through the session may include a procedure 240 of transmitting packets 241, 242, 243, and 244 for identifying possession of the identity information of the session, a procedure 250 of transmitting packets (or acknowledgement packets) 251, 252, 253, and 254 indicating that the identity information of the session has been identified, a procedure 260 of transmitting packets 261, 262, 263, and 264 for identifying possession of the key, and a procedure 270 of transmitting packets (or acknowledgement packets) 271, 272, 273, and 274 indicating that the key has been identified.

According to an example, the electronic device 210 and the external electronic device 220 may not use a session initiation protocol (SIP) and/or a session description protocol (SDP) of an IMS when generating a packet for identifying possession of identity information of a session and a key. A packet generated using the SIP and/or SDP may cause a problem in some electronic devices. Therefore, the electronic device 210 and the external electronic device 220 may generate a packet using a real-time protocol (RTP) rather than the SIP and/or SDP.

A packet generated using the RTP may be transmitted through a user datagram protocol (UDP). When a packet is exchanged through the UDP, the integrity of transmission and/or reception of the packet may not be ensured. Therefore, the electronic device 210 and the external electronic device 220 may transmit the same packet a predetermined number of times so that a counterpart who is to receive the packet is able to receive same.

Referring to FIG. 2B, the electronic device 210 may transmit a packet 241 indicating that the electronic device 210 has identity information of a session to the external electronic device 220. The electronic device 210 may, after expiration of a designated time after the transmission of the packet 241 has completed, transmit, to the external electronic device 220, a packet 243 indicating that the electronic device 210 has the identity information of the session. The packets 241 and 243 may include the same information (e.g., this indicates that the electronic device 210 has the identity information of the session), and may be transmitted according to a designated number of times (e.g., 2 times) so that the external electronic device 220 is able to successfully receive the packet.

The external electronic device 220 may transmit, to the electronic device 210, a packet 242 indicating that the external electronic device 220 has the identity information of the session. According to an example, the external electronic device 220 may, when a call transmitted by the electronic device 210 is received, request information indicating whether the electronic device 210 supports quantum-encrypted calls, from the quantum encryption server 232. The quantum encryption server 232 may transmit the information indicating whether the electronic device 210 supports quantum-encrypted calls to the external electronic device 220. The external electronic device 220 may identify whether the electronic device 210 supports quantum-encrypted calls, based on the information indicating whether the electronic device 210 supports quantum-encrypted calls. In FIG. 2B, the electronic device 210 is, for ease of explanation, assumed to support quantum-encrypted calls. The external electronic device 220 may, in a case where the electronic device 210 supports quantum-encrypted calls, transmit, to the electronic device 210, the packet 242 indicating that the external electronic device 220 has the identity information of the session. The external electronic device 220 may, after expiration of a designated time after the transmission of the packet 242 has completed, transmit, to the electronic device 210, a packet 244 indicating that the external electronic device 220 has the identity information of the session. The packets 242 and 244 may include the same information (e.g., this indicates that the external electronic device 220 has the identity information of the session), and may be transmitted according to a designated number of times (e.g., 2 times) so that the electronic device 210 is able to successfully receive the packet.

The electronic device 210 may, when at least one of the packets 242 and 244 indicating that the external electronic device 220 has the identity information of the session is successfully received, compare the identity information included in the packet 242 or 244 with the identity information possessed by the electronic device 210. When the identity information included in the packet 242 or 244 matches the identity information possessed by the electronic device 210, the electronic device 210 may transmit, to the external electronic device 220, a packet (confirm session ID) 251 indicating that the identity information of the session has been identified. The electronic device 210 may, after expiration of a designated time after the transmission of the packet 251 has completed, transmit, to the external electronic device 220, a packet 253 indicating that the electronic device 210 has identified the identity information of the session.

The external electronic device 220 may, when at least one of the packets 241 and 243 indicating that the electronic device 210 has the identity information of the session is successfully received, compare the identity information included in the packet 241 or 243 with the identity information possessed by the external electronic device 220. When the identity information included in the packet 241 or 243 matches the identity information possessed by the external electronic device 220, the external electronic device 220 may transmit, to the electronic device 210, a packet (confirm session ID) 252 indicating that the identity information of the session has been identified. The external electronic device 220 may, after expiration of a designated time after the transmission of the packet 252 has completed, transmit, to the electronic device 210, a packet 254 indicating that the external electronic device 220 has identified the identity information of the session.

The electronic device 210 may, when at least one of the packets 252 and 254 indicating that the external electronic device 220 has identified the identity information of the session is successfully received, transmit, to the external electronic device 220, a packet 261 including information indicating whether the electronic device 210 has a key used for encryption of data transmitted and/or received through the session. When the electronic device 210 has the key, the electronic device 210 may transmit, to the external electronic device 220, a packet (has session key) 261 including information indicating that the electronic device has the key. The electronic device 210 may, after expiration of a designated time after the transmission of the packet 261 has completed, transmit, to the external electronic device 220, a packet (has session key) 263 including information indicating that the electronic device 210 has the key.

The external electronic device 220 may, when at least one of the packets 251 and 253 indicating that the electronic device 210 has identified the identity information of the session is successfully received, transmit, to the electronic device 210, a packet 262 including information indicating whether the external electronic device 220 has a key used for encryption of data transmitted and/or received through the session. When the external electronic device 220 has the key, the external electronic device 220 may transmit, to the electronic device 210, a packet (has session key) 262 including information indicating that the external electronic device has the key. The external electronic device 220 may, after expiration of a designated time after the transmission of the packet 262 has completed, transmit, to the electronic device 210, a packet (has session key) 264 including information indicating that the external electronic device 220 has the key.

The electronic device 210 may, when at least one of the packets (has session key) 262 and 264 including the information indicating that the external electronic device 220 has the key is successfully received, identify whether the key included in the packet 262 or 264 matches the key possessed by the electronic device 210. The electronic device 210 may identify that the key included in the packet 262 or 264 matches the key possessed by the electronic device 210, and transmit a packet (confirm session key) 271 indicating that the key has been identified to the external electronic device 220. The electronic device 210 may, after expiration of a designated time after the transmission of the packet 271 has completed, transmit, to the external electronic device 220, a packet (confirm session key) 273 indicating that the key has been identified.

The external electronic device 220 may, when at least one of the packets (has session key) 261 and 263 including the information indicating that the electronic device 210 has the key is successfully received, identify whether the key included in the packet 261 or 263 matches the key possessed by the external electronic device 220. The external electronic device 220 may identify that the key included in the packet 261 or 263 matches the key possessed by the external electronic device 220, and transmit a packet (confirm session key) 272 indicating that the key has been identified to the electronic device 210. The external electronic device 220 may, after expiration of a designated time after the transmission of the packet 272 has completed, transmit a packet (confirm session key) 274 indicating that the key has been identified to the electronic device 210.

As in the example method described above, the electronic device 210 and the external electronic device 220 may perform a procedure of identifying identity information of a session to be established between the electronic device 210 and the external electronic device 220 and a key transmitted and/or received through the session. Referring to FIG. 2B, the electronic device 210 and the external electronic device 220 may transmit the same packet a designated number of times (e.g., 2 times) according to a characteristic of the UDP.

The repetition of packet transmission may increase the time taken to configure a quantum-encrypted call. According to an example, the greater the number of times of packet transmission, the greater the time taken to configure a quantum-encrypted call.

Referring to FIG. 2B, the electronic device 210 and the external electronic device 220 may perform 4 stages 240, 250, 260, and 270 for configuring a quantum-encrypted call. The greater the number of stages required to be performed, the greater the time taken to configure a quantum-encrypted call.

The following description provides an example in which the electronic device 210 determines (or adjust or change) the number of times of packet transmission, based on a status of a channel between the electronic device 210 and the cellular network 230 in order to reduce the time taken to configure a quantum-encrypted call.

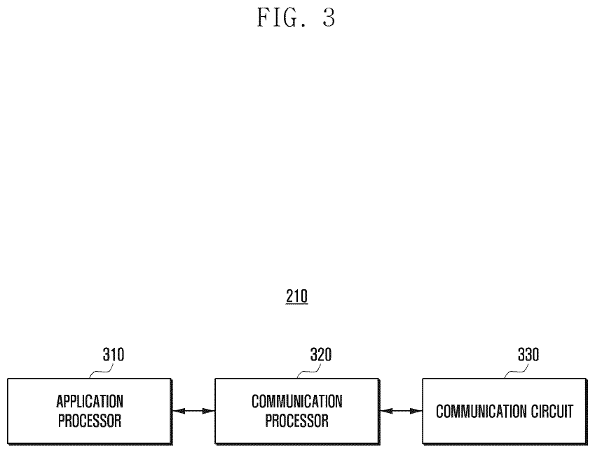

FIG. 3 is a block diagram illustrating an example configuration of an electronic device according to various embodiments.

An electronic device (e.g., the electronic device 210 in FIG. 2A) may include an application processor (e.g., including processing circuitry) 310 (e.g., the processor 120 or the main processor 121 in FIG. 1), a communication processor (e.g., including processing circuitry) 320 (e.g., the auxiliary processor 123 in FIG. 1), and/or a communication circuit 330 (e.g., the wireless communication module 192 in FIG. 1).

The application processor 310 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The application processor 310 may, for example, control various elements of the electronic device 101. The application processor 310 may execute an application non-temporarily or temporarily stored in a memory (e.g., the memory 130 in FIG. 1), based on a user input.

The communication processor 320 may include various processing circuitry as described above with respect to the application processor 310, the processor 120, the auxiliary processor 123, or the like. The communication processor 320 may perform data transmission and/or reception through cellular communication. The communication processor 320 may be connected to a cellular network (e.g., the cellular network 230 in FIG. 2A) through cellular communication. The communication processor 320 may transmit user data received from the application processor 310 through cellular communication, and transmit user data received through cellular communication to the application processor 310.

The communication circuit 330 may include a communication circuit supporting cellular communication, and may provide communication with an external electronic device (e.g., the external electronic device 104 in FIG. 1) to the electronic device 210 through cellular communication.

According to an example, the application processor 310 may execute a call application that performs a voice call and/or video call, according to various causes (e.g., a user input). The application processor 310 may, after executing the call application, perform a series of operations for performing a call with an external electronic device (e.g., the external electronic device 220 in FIG. 2A) corresponding to the counterpart of the call.

According to an example, the application processor 310 may establish a session between the electronic device 210 and the external electronic device 220 according to the initiation of a call. The session may indicate a passage through which the electronic device 210 and/or the external electronic device 220 exchanges data related to the call.

Hereinafter, for convenience of explanation, it is assumed that the electronic device 210 is an electronic device (mobile oriented (MO)) which originates a call and the external electronic device 220 which terminates a call is an electronic device (mobile terminated (MT)).

The electronic device 210 may support a quantum-encrypted call. A quantum-encrypted call may be a call of a scheme of encrypting or decrypting packets (or data) transmitted and/or received during the call using a quantum password. Such a quantum-encrypted call is implemented in a scheme of exchanging encrypted packets (or data) using quantum mechanical characteristics to make eavesdropping or interception difficult and is thus highly regarded in terms of security. In a case where the cellular network 230 connected to the electronic device 210 and/or the external electronic device 220 support a quantum-encrypted call, the electronic device 210 may perform the quantum-encrypted call with the external electronic device 220.

The application processor 310 may receive, according to initiation of a call, identity information of a session of a quantum-encrypted call and a key used in the quantum-encrypted call from the cellular network 230 supporting the quantum-encrypted call.

The identity information of the session and the key of the quantum-encrypted call may be stored in a quantum encryption server (e.g., the quantum encryption server 232 in FIG. 2A) of the cellular network 230. The application processor 310 may request, from the quantum encryption server 232, information required for a quantum-encrypted call at the time of initiation of a call or before initiation of a call. The application processor 310 may receive identity information of a session and a key from the quantum encryption server 232.

A quantum-encrypted call may be activated when the electronic device 210 and the external electronic device 220 performing the quantum-encrypted call have the same identity information of a session and the same key. Therefore, the application processor 310 may, before a quantum-encrypted call is activated, perform a series of operations of identifying whether the external electronic device 220 has the same identity information and the same key as the identity information of a session and the key possessed by the electronic device 210.

The application processor 310 may transmit, to the external electronic device 220 a pre-designated number of times, a packet (e.g., the packet 241 or 243 in FIG. 2B) for identifying whether the external electronic device 220 has identity information of a session and/or a packet (e.g., the packet 261 or 263 in FIG. 2B) for identifying whether the external electronic device 220 has a key, so as to identify whether the external electronic device 220 has the same identity information and the same key as the identity information of the session and the key possessed by the electronic device 210.

The application processor 310 may not use a session initiation protocol (SIP) and/or a session description protocol (SDP) of an IMS when generating a packet for identifying whether the external electronic device 220 has identity information of a session and a key. A packet generated using the SIP and/or SDP may cause a problem in some electronic devices. Therefore, the application processor 310 may generate a packet using a real-time protocol (RTP) rather than the SIP and/or SDP.

A packet generated using the RTP may be transmitted through a user datagram protocol (UDP). When a packet is exchanged through the UDP, the integrity of transmission and/or reception of the packet may not be ensured. Therefore, the application processor 310 may transmit the same packet a predetermined number of times so that a counterpart who is to receive the packet is able to receive same. The repetition of packet transmission may increase the time taken to configure a quantum-encrypted call. According to an example, the greater the number of times of packet transmission, the greater the time taken to configure a quantum-encrypted call.

The application processor 310 may determine (or adjust or change) the number of times of packet transmission, based on a status of a channel between the electronic device 210 and the cellular network 230.

According to an example, the application processor 310 may determine the number of times of packet transmission, based on information (e.g., the loss rate of a packet) related to the loss of a packet received by the electronic device 210 from the cellular network 230 and/or information (e.g., the occurrence rate of jitter) related to the occurrence of jitter of a packet received by the electronic device 210 from the cellular network 230.

The greater the loss rate of the packet, the lower the probability that the external electronic device 220 receives at least one packet for identifying whether the external electronic device 220 has identity information of a session and a key. Therefore, as the loss rate of a packet becomes greater, the application processor 310 may increase the number of times of transmission of at least one packet for identifying whether the external electronic device 220 has identity information of a session and a key.

According to an example, the application processor 310 may determine the number of times of transmission of at least one packet for identifying whether the external electronic device 220 has identity information of a session and a key, by referring to mapping data in which the loss rate of a packet and the number of times of transmission are mapped. The mapping data may be implemented as shown in Table 1 below.

TABLE 1

| Loss rate | Number of times of transmission |
|---|---|
| Loss rate <1% | 2 |
| 1% < loss rate < 5% | 3 |
| 5% < loss rate < 10% | 4 |
| Loss rate >10% | 5 |

For example, when the loss rate of a packet is included in a designated range (e.g., equal to or smaller than 1%), the application processor 310 may determine (or configure) a first value (e.g., 2 times) as the number of times of transmission of at least one packet for identifying whether the external electronic device 220 has identity information of a session and a key.

For example, when the loss rate of a packet is included in a designated range (e.g., equal to or greater than 1% and equal to or smaller than 5%), the application processor 310 may determine (or configure) a second value (e.g., 3 times) as the number of times of transmission of at least one packet for identifying whether the external electronic device 220 has identity information of a session and a key.

The greater the occurrence rate of jitter, the lower the probability that the external electronic device 220 receives at least one packet for identifying whether the external electronic device 220 has identity information of a session and a key. Therefore, as the occurrence rate of jitter becomes greater, the application processor 310 may increase the number of times of transmission of at least one packet for identifying whether the external electronic device 220 has identity information of a session and a key.

According to an example, the application processor 310 may determine the number of times of transmission of at least one packet for identifying whether the external electronic device 220 has identity information of a session and a key, by referring to mapping data in which the occurrence rate of jitter and the number of times of transmission are mapped. The mapping data may be implemented as shown in Table 2 below.

TABLE 2

| Occurrence rate of jitter | Number of times of transmission |
|---|---|
| Occurrence rate of jitter <1% | 2 |
| 1% < occurrence rate of jitter < 5% | 3 |
| 5% < occurrence rate of jitter < 10% | 4 |
| Occurrence rate of jitter >10% | 5 |

For example, when the occurrence rate of jitter is included in a designated range (e.g., equal to or smaller than 1%), the application processor 310 may determine (or configure) a first value (e.g., 2 times) as the number of times of transmission of at least one packet for identifying whether the external electronic device 220 has identity information of a session and a key.

For example, when the occurrence rate of jitter is included in a designated range (e.g., equal to or greater than 1% and equal to or smaller than 5%), the application processor 310 may determine (or configure) a second value (e.g., 3 times) as the number of times of transmission of at least one packet for identifying whether the external electronic device 220 has identity information of a session and a key.

The application processor 310 may also determine the number of times of transmission of at least one packet for identifying whether the external electronic device 220 has identity information of a session and a key, by considering both the loss rate of a packet and the occurrence rate of jitter.

According to an example, the application processor 310 may determine the number of times of transmission of at least one packet for identifying whether the external electronic device 220 has identity information of a session and a key, by referring to mapping data in which the loss rate of a packet and the occurrence rate of jitter, and the number of times of transmission are mapped. The mapping data may be implemented as shown in Table 3 below.

TABLE 3

| Occurrence rate of jitter and | |
|---|---|
| loss rate of packet | Number of times of transmission |
| Occurrence rate of jitter <1% | 2 |
| Loss rate of packet <1% | |
| Occurrence rate of jitter >10% | 5 |
| Loss rate of packet >10% | |
| Others | 3 |

For example, when the occurrence rate of jitter is included in a designated range (e.g., equal to or smaller than 1%) and the loss rate of a packet is included in a designated range (e.g., equal to or smaller than 1%), the application processor 310 may determine (or configure) a first value (e.g., 2 times) as the number of times of transmission of at least one packet for identifying whether the external electronic device 220 has identity information of a session and a key.

For example, when the occurrence rate of jitter is included in a designated range (e.g., equal to or greater than 10%) and the loss rate of a packet is included in a designated range (e.g., equal to or greater than 10%), the application processor 310 may determine (or configure) a second value (e.g., 5 times) as the number of times of transmission of at least one packet for identifying whether the external electronic device 220 has identity information of a session and a key.

The example described above shows an example in which the application processor 310 determines the number of times of transmission of at least one packet for identifying whether the external electronic device 220 has identity information of a session and a key, based on the occurrence rate of jitter and the loss rate of a packet. However, the disclosure may not be limited thereto.

According to an example, the application processor 310 may determine the number of times of transmission of at least one packet for identifying whether the external electronic device 220 has identity information of a session and a key, by referring to information (e.g., an uplink grant or a downlink grant) related to resources allocated by the cellular network 230 to the electronic device 210. For example, as the resources allocated by the cellular network 230 to the electronic device 210 becomes larger, the application processor 310 may configure less transmissions of at least one packet for identifying whether the external electronic device 220 has identity information of a session and a key. The larger the resources allocated by the cellular network 230 to the electronic device 210, the greater the probability that the external electronic device 220 receives at least one packet for identifying whether the external electronic device 220 has identity information of a session and a key.

According to an example, the application processor 310 may determine the number of times of transmission of at least one packet for identifying whether the external electronic device 220 has identity information of a session and a key, by referring to an error rate (e.g., an uplink block error rate (BLER) or a downlink block error rate (BLER)) measured by the cellular network. For example, as the error rate measured by the cellular network becomes greater, the application processor 310 may configure more transmissions of at least one packet for identifying whether the external electronic device 220 has identity information of a session and a key. The greater the error rate measured by the cellular network, the smaller the probability that the external electronic device 220 receives at least one packet for identifying whether the external electronic device 220 has identity information of a session and a key.

According to an example, the application processor 310 may determine the number of times of transmission of at least one packet for identifying whether the external electronic device 220 has identity information of a session and a key, based on a quality (RSSI or RSRP) of a signal measured by the communication circuit 330. For example, as the quality of the signal measured by the communication circuit 330 becomes greater, the application processor 310 may configure less transmissions of at least one packet for identifying whether the external electronic device 220 has identity information of a session and a key. The greater the quality of the signal measured by the communication circuit 330, the greater the probability that the external electronic device 220 receives at least one packet for identifying whether the external electronic device 220 has identity information of a session and a key.

The application processor 310 may determine the number of times of transmission of at least one packet for identifying whether the external electronic device 220 has identity information of a session and a key, by considering both a status of a channel between the electronic device 210 and the cellular network 230 and a previously measured status of a channel between the electronic device 210 and the cellular network 230.

The application processor 310 may also determine a transmission interval of at least one packet for identifying whether the external electronic device 220 has identity information of a session and a key, based on a status of a channel between the electronic device 210 and the cellular network 230. The better the status of the channel between the electronic device 210 and the cellular network 230, the application processor may configure, to be relatively short, the transmission interval of at least one packet for identifying whether the external electronic device 220 has identity information of a session and a key. The worse the status of the channel between the electronic device 210 and the cellular network 230, the application processor 310 may configure, to be relatively long, the transmission interval of at least one packet for identifying whether the external electronic device 220 has identity information of a session and a key. When the status of the channel between the electronic device 210 and the cellular network 230 is bad and the transmission interval of at least one packet for identifying whether the external electronic device 220 has identity information of a session and a key is short, the congestion level of the channel may be increased.

The application processor 310 may transmit at least one packet to the external electronic device 220, based on the designated transmission interval according to the determined number of times of transmission.

The application processor 310 may transmit, to the external electronic device 220, the packet 241 indicating that the electronic device 210 has identity information of a session. The application processor 310 may, after expiration of a designated time after the transmission of the packet 241 has completed, transmit, to the external electronic device 220, the packet 243 indicating that the electronic device 210 has the identity information of the session. The packets 241 and 243 may include the same information (e.g., this indicates that the electronic device 210 has the identity information of the session), and may be transmitted according to a determined number of times so that the external electronic device 220 is able to successfully receive the packet.

The external electronic device 220 may transmit, to the electronic device 210, the packet 242 indicating that the external electronic device 220 has the identity information of the session. The external electronic device 220 may, after expiration of a designated time after the transmission of the packet 242 has completed, transmit, to the electronic device 210, the packet 244 indicating that the external electronic device 220 has the identity information of the session. The packets 242 and 244 may include the same information (e.g., this indicates that the external electronic device 220 has the identity information of the session), and may be transmitted according to a determined number of times so that the electronic device 210 is able to successfully receive the packet. The external electronic device 220 may determine the number of times of transmission of the packets 242 and 244 in the same method as a method in which the electronic device 210 determines the number of times of transmission of the packets 241 and 243.

The application processor 310 may, when at least one of the packets 242 and 244 indicating that the external electronic device 220 has the identity information of the session is successfully received, compare the identity information included in the packet 242 or 244 with the identity information possessed by the electronic device 210. When the identity information included in the packet 242 or 244 matches the identity information possessed by the electronic device 210, the application processor 310 may transmit, to the external electronic device 220, the packet (confirm session ID) 251 indicating that the identity information of the session has been identified. The application processor 310 may, after expiration of a designated time after the transmission of the packet 251 has completed, transmit, to the external electronic device 220, a packet 253 indicating that the application processor 310 has identified the identity information of the session.

The external electronic device 220 may, when at least one of the packets 241 and 243 indicating that the electronic device 210 has the identity information of the session is successfully received, compare the identity information included in the packet 241 or 243 with the identity information possessed by the external electronic device 220. When the identity information included in the packet 241 or 243 matches the identity information possessed by the external electronic device 220, the external electronic device 220 may transmit, to the electronic device 210, the packet (confirm session ID) 252 indicating that the identity information of the session has been identified. The external electronic device 220 may, after expiration of a designated time after the transmission of the packet 252 has completed, transmit, to the electronic device 210, the packet 254 indicating that the external electronic device 220 has identified the identity information of the session.

The application processor 310 may, when at least one of the packets 252 and 254 indicating that the external electronic device 220 has identified the identity information of the session is successfully received, transmit, to the external electronic device 220, the packet 261 including information indicating whether the electronic device 210 has a key used for encryption of data transmitted and/or received through the session. When the electronic device 210 has the key, the application processor 310 may transmit, to the external electronic device 220, the packet (has session key) 261 including information indicating that the electronic device has the key. The application processor 310 may, after expiration of a designated time after the transmission of the packet 261 has completed, transmit, to the external electronic device 220, the packet (has session key) 263 including information indicating that the electronic device 210 has the key.

The external electronic device 220 may, when at least one of the packets 251 and 253 indicating that the application processor 310 has identified the identity information of the session is successfully received, transmit, to the electronic device 210, the packet 262 including information indicating whether the external electronic device 220 has a key used for encryption of data transmitted and/or received through the session. When the external electronic device 220 has the key, the external electronic device 220 may transmit, to the electronic device 210, the packet (has session key) 262 including information indicating that the external electronic device has the key. The external electronic device 220 may, after expiration of a designated time after the transmission of the packet 262 has completed, transmit, to the electronic device 210, the packet (has session key) 264 including information indicating that the external electronic device 220 has the key.

The application processor 310 may, when at least one of the packets (has session key) 262 and 264 including the information indicating that the external electronic device 220 has the key is successfully received, identify whether the key included in the packet 262 or 264 matches the key possessed by the electronic device 210. The application processor 310 may identify that the key included in the packet 262 or 264 matches the key possessed by the electronic device 210, and transmit the packet (confirm session key) 271 indicating that the key has been identified to the external electronic device 220. The application processor 310 may, after expiration of a designated time after the transmission of the packet 271 has completed, transmit, to the external electronic device 220, the packet (confirm session key) 273 indicating that the key has been identified.

The external electronic device 220 may, when at least one of the packets (has session key) 261 and 263 including the information indicating that the electronic device 210 has the key is successfully received, identify whether the key included in the packet 261 or 263 matches the key possessed by the external electronic device 220. The external electronic device 220 may identify that the key included in the packet 261 or 263 matches the key possessed by the external electronic device 220, and transmit the packet (confirm session key) 272 indicating that the key has been identified to the electronic device 210. The external electronic device 220 may, after expiration of a designated time after the transmission of the packet 272 has completed, transmit the packet (confirm session key) 274 indicating that the key has been identified to the electronic device 210.

According to an example, the application processor 310 may transmit a packet including both the identity information of the session and information indicating that the electronic device 210 has the key, to the external electronic device 220 according to a determined number of times of transmission so as to reduce the time taken to configure a quantum-encrypted call. The external electronic device 220 may also transmit, to the electronic device 210, a packet including both the identity information of the session and information indicating that the external electronic device 220 has the key. When the packet including all the information indicating that the external electronic device 220 has the identity information of the session and the key is received, the application processor 310 may identify whether the identity information of the session included in the packet matches the identity information possessed by the electronic device 210 and whether the key included in the packet matches the key possessed by the electronic device 210. The application processor 310 may transmit, to the external electronic device 220, a packet indicating that the identity information of the session and the key have been identified, based on that the identity information of the session included in the packet matches the identity information possessed by the electronic device 210 and the key included in the packet matches the key possessed by the electronic device 210.

The application processor 310 may identify that the external electronic device 220 has the identity information of the session and the key, through the method described above, and activate a quantum-encrypted call. The application processor 310 may transmit the identity information of the session and the key to the communication processor 320 according to the activation of the quantum-encrypted call. The application processor 310 may output information (or indicator) indicating that the quantum-encrypted call is being configured, while activating the quantum-encrypted call.

The communication processor 320 may, according to the activation of the quantum-encrypted call, receive an external input including a user's speech through a microphone (e.g., the input module 150 in FIG. 1) operatively connected to the communication processor 320, and perform quantum encryption of data corresponding to the external input using the key. The communication processor 320 may transmit the encrypted data to the external electronic device 220 through the session.

The communication processor 320 may receive the encrypted data from the external electronic device 220 and decrypt same using the key. The communication processor 320 may output a signal corresponding to the decrypted data through a speaker (e.g., the sound output module 155 in FIG. 1) operatively connected to the communication processor 320.

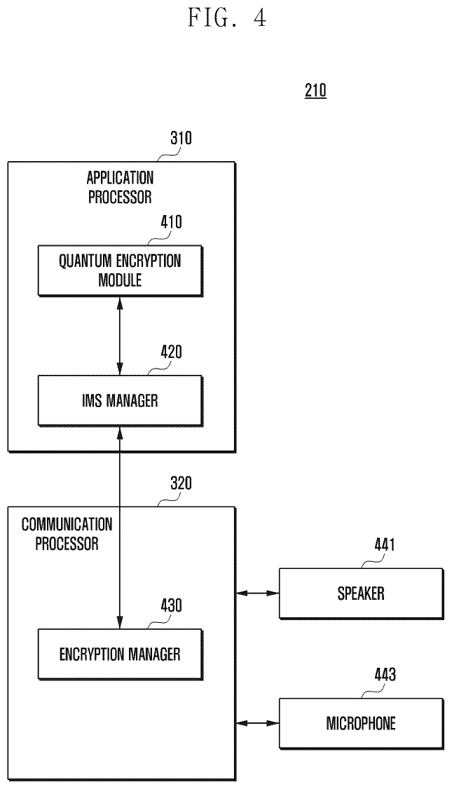

FIG. 4 is a block diagram illustrating an example configuration of an electronic device according to various embodiments.

Referring to FIG. 4, an electronic device (e.g., the electronic device 210 in FIG. 3) may include an application processor (e.g., the application processor 310 in FIG. 3) and a communication processor (e.g., the communication processor 320 in FIG. 3).

The application processor 310 may include a quantum encryption module (e.g., including various circuitry and/or executable program instructions) 410 (e.g., the quantum encryption module 212 in FIG. 2A) and an IMS manager (e.g., including various circuitry and/or executable program instructions) 420 (e.g., the IMS module 211 in FIG. 2A).

The quantum encryption module 410 may request and/or receive information required for a quantum-encrypted call from the quantum encryption server 232 of the cellular network 230. The information required for a quantum-encrypted call may include identity information of a session to be established between the electronic device 210 and the external electronic device 220, and a key that is able to be used for encryption of a packet (or data) to be transmitted and/or received through the session. According to an example, a key used for quantum encryption may include information of a polarizing filter to be used for encryption or decryption of data. The quantum encryption module 410 may receive information required for a quantum-encrypted call from the quantum encryption server 232 and transmit the information required for the quantum-encrypted call to an encryption manager 430.

The IMS manager 420 is an entity that performs origination and/or termination of a call, and may establish a session for a call using a session initiation protocol (SIP).

The communication processor 320 may include the encryption manager (e.g., including various circuitry and/or executable program instructions) 430 (e.g., the encryption manager 213 in FIG. 2A). The encryption manager 430 may be an entity that encrypts or decrypts data transmitted and/or received through a session established between the electronic device 210 and the external electronic device 220. The encryption manager 213 in FIG. 2A is implemented in the application processor 310, but the encryption manager 430 of the disclosure may be implemented in the communication processor 320 rather than the application processor 310. The encryption manager 430 is implemented in the communication processor 320 so that the communication processor 320 may perform quantum encryption of data or decrypt quantum-encrypted data.

The communication processor 320 may receive encrypted data from the external electronic device 220 and decrypt same using a key. The communication processor 320 may output a signal corresponding to the decrypted data through a speaker 441 (e.g., the sound output module 155 in FIG. 1) operatively connected to the communication processor 320. The speaker 441 may be operatively connected to the communication processor 320 when a quantum-encrypted call is activated. Therefore, decrypted data may be output to the speaker 441 not through the application processor 310, thereby preventing (or reducing) exposure of data caused by the vulnerability of the application processor 310. The speaker 441 may be operatively connected to the application processor 310 in a case where a quantum-encrypted call is not activated and/or various cases (e.g., in a case where an application or function for outputting sound is activated).

The communication processor 320 may, according to the activation of a quantum-encrypted call, receive an external input including a user's speech through a microphone 443 (e.g., the input module 150 in FIG. 1) operatively connected to the communication processor 320, and perform quantum encryption of data corresponding to the external input using a key. The communication processor 320 may transmit the encrypted data to the external electronic device 220 through a session. The microphone 443 may be operatively connected to the communication processor 320 when a quantum-encrypted call is activated. Therefore, encrypted data corresponding to a speech obtained through the microphone 443 may be transmitted to the external electronic device 220 not through the application processor 310, thereby preventing (or reducing) exposure of data caused by the vulnerability of the application processor 310.

The microphone 443 may be operatively connected to the application processor 310 in a case where a quantum-encrypted call is not activated and/or various cases (e.g., in a case where an application or function for collecting sound is activated).

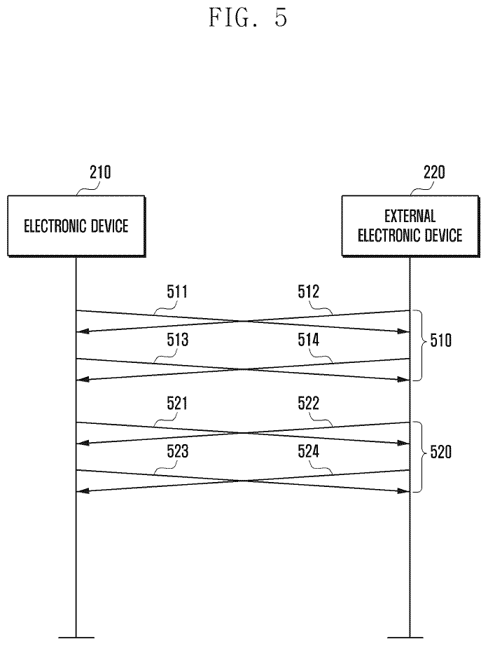

FIG. 5 is a signal flow diagram illustrating an example in which an electronic device transmits and/or receives at least one packet for identifying whether an external electronic device has identity information of a session and/or a key of a quantum-encrypted call according to various embodiments.

An electronic device (e.g., the electronic device 210 in FIG. 3) may perform, in order to activate a quantum-encrypted call, a series of operations for identifying whether an external electronic device (e.g., the external electronic device 220 in FIG. 2A) has identity information of a session and/or a key used for encryption and/or decryption of data through the session.

The electronic device 210 described with reference to FIG. 3 may perform an operation of transmitting a packet (e.g., the packet 241 or 243 in FIG. 2B) for identifying whether the external electronic device 220 has identity information of a session, to the external electronic device 220 according to a determined number of times of transmission, and an operation of transmitting a packet (e.g., the packet 261 or 263 in FIG. 2B) for identifying whether the external electronic device 220 has a key, to the external electronic device 220 according to a determined number of times of transmission.

For example, if the determined number of times of transmission is 3 times, the electronic device 210 may transmit, a total of 6 times, a packet (e.g., the packet 241 or 243 in FIG. 2B) for identifying whether the external electronic device 220 has the identity information of the session, and a packet (e.g., the packet 261 or 263 in FIG. 2B) for identifying whether the external electronic device 220 has the key. The increment in the number of times of transmission may increase the time taken to configure a quantum-encrypted call.

The electronic device 210 may transmit a packet including both the identity information of the session and information indicating that the electronic device 210 has the key, to the external electronic device 220 according to a determined number of times of transmission so as to reduce the time taken to configure a quantum-encrypted call. The external electronic device 220 may also transmit, to the electronic device 210, a packet including both the identity information of the session and information indicating that the external electronic device 220 has the key.

The electronic device 210 using the method described above may perform an operation 510 of transmitting a packet including both the identity information of the session and information indicating that the electronic device 210 has the key, to the external electronic device 220 according to a determined number of times of transmission, and an operation 520 of transmitting a packet including information indicating that it has been identified that the external electronic device 220 has the same identity information of the session and the same key as those of the electronic device 210, to the external electronic device 220 according to a determined number of times of transmission.

Referring to FIG. 5, the electronic device 210 may transmit, to the external electronic device 220, a packet 511 including both the identity information of the session and information indicating that the electronic device 210 has the key. The electronic device 210 may, after expiration of a designated time after the transmission of the packet 511 has completed, transmit, to the external electronic device 220, a packet 513 including both the identity information of the session and information indicating that the electronic device 210 has the key.

The external electronic device 210 may transmit, to the electronic device 210, a packet 512 including both the identity information of the session and information indicating that the external electronic device 220 has the key. The external electronic device 220 may, after expiration of a designated time after the transmission of the packet 512 has completed, transmit, to the electronic device 210, a packet 514 including both the identity information of the session and information indicating that the external electronic device 220 has the key.

When at least one of the packets 512 and 514 each including both the identity information of the session and the information indicating that the external electronic device 220 has the key is received, the electronic device 210 may identify whether the identity information of the session included in the packet 512 or 514 matches the identity information possessed by the electronic device 210 and whether the key included in the packet 512 or 514 matches the key possessed by the electronic device 210.

The electronic device 210 may transmit, to the external electronic device 220, a packet 521 indicating that the identity information of the session and the key have been identified, based on that the identity information of the session included in the packet 512 or 514 matches the identity information possessed by the electronic device 210 and the key included in the packet 512 or 514 matches the key possessed by the electronic device 210. The electronic device 210 may, after expiration of a designated time after the transmission of the packet 521 has completed, transmit, to the external electronic device 220, a packet 523 indicating that the identity information of the session and the key have been identified.

When at least one of the packets 511 and 513 each including both the identity information of the session and the information indicating that the electronic device 210 has the key is received, the external electronic device 220 may identify whether the identity information of the session included in the packet 511 or 513 matches the identity information possessed by the external electronic device 220 and whether the key included in the packet 511 or 513 matches the key possessed by the external electronic device 220.

The external electronic device 220 may transmit, to the electronic device 210, a packet 522 indicating that the identity information of the session and the key have been identified, based on that the identity information of the session included in the packet 511 or 513 matches the identity information possessed by the external electronic device 220 and the key included in the packet 511 or 513 matches the key possessed by the external electronic device 220. The external electronic device 220 may, after expiration of a designated time after the transmission of the packet 522 has completed, transmit, to the electronic device 210, a packet 524 indicating that the identity information of the session and the key have been identified.

Referring to the example illustrated in FIG. 5, the electronic device 210 and the external electronic device 220 may reduce the number of times (or stages) of transmission of a packet for identifying possession of the identify information of the session and the key, thereby reducing the time taken to configure a quantum-encrypted call.

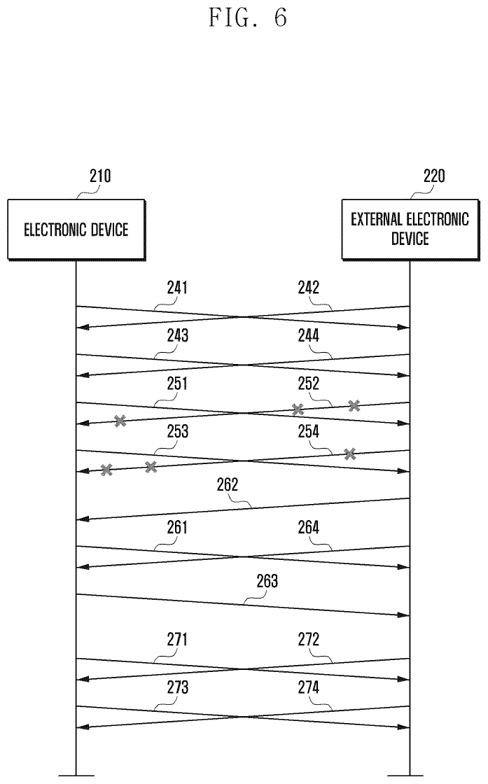

FIG. 6 is a signal flow diagram illustrating an example in which an electronic device transmits and/or receives at least one packet for identifying whether an external electronic device has identity information of a session and/or a key of a quantum-encrypted call according to various embodiments.

An electronic device (e.g., the electronic device 210 in FIG. 3) may perform, in order to activate a quantum-encrypted call, a series of operations for identifying whether an external electronic device (e.g., the external electronic device 220 in FIG. 2A) has identity information of a session and/or a key used for encryption and/or decryption of data through the session.

The electronic device 210 may perform an operation of transmitting a packet (e.g., the packet 241 or 243 in FIG. 2B) for identifying whether the external electronic device 220 has the identity information of the session, to the external electronic device 220 according to a determined number of times of transmission. The electronic device 210 may, when a packet indicating that the external electronic device 220 has identified the identity information of the session is received, perform an operation of transmitting a packet (e.g., the packet 261 or 263 in FIG. 2B) for identifying whether the external electronic device 220 has the key, to the external electronic device 220 according to a determined number of times of transmission.

According to an example, the electronic device 210 may fail to receive the packet indicating that the external electronic device 220 has identified the identity information of the session, according to various causes. For example, when a status of a channel between the electronic device 210 and the cellular network 230 has temporarily degraded, the electronic device 210 may fail to receive the packet indicating that the external electronic device 220 has identified the identity information of the session. When the electronic device 210 has failed to receive the packet indicating that the external electronic device 220 has identified the identity information of the session, the electronic device is unable to transmit the packet (e.g., the packet 261 or 263 in FIG. 2B) for identifying whether the external electronic device 220 has the key, to the external electronic device 220 according to a determined number of times of transmission, and thus may fail to configure a quantum-encrypted call. When configuration of a quantum-encrypted call fails, the electronic device 210 and the external electronic device 220 may perform a general call requiring no encryption operation. However, in a case where a status of a channel between the electronic device 210 and the cellular network 230 has temporarily degraded, even though a quantum-encrypted call is possible, the quantum-encrypted call may fail. Therefore, even when the electronic device 210 has failed to receive the packet indicating that the external electronic device 220 has identified the identity information of the session, if a particular condition is satisfied, the electronic device transmits the packet (e.g., the packet 261 or 263 in FIG. 2B) for identifying whether the external electronic device 220 has the key, to the external electronic device 220 according to a determined number of times of transmission, so that configuration of a quantum-encrypted call may be performed.

The electronic device 210 may transmit, to the external electronic device 220, a packet 241 indicating that the electronic device 210 has the identity information of the session. The electronic device 210 may, after expiration of a designated time after the transmission of the packet 241 has completed, transmit, to the external electronic device 220, a packet 243 indicating that the electronic device 210 has the identity information of the session. The packets 241 and 243 may include the same information (e.g., this indicates that the electronic device 210 has the identity information of the session), and may be transmitted according to a determined number of times so that the external electronic device 220 is able to successfully receive the packet.

The external electronic device 220 may transmit, to the electronic device 210, a packet 242 indicating that the external electronic device 220 has the identity information of the session. The external electronic device 220 may, after expiration of a designated time after the transmission of the packet 242 has completed, transmit, to the electronic device 210, a packet 244 indicating that the external electronic device 220 has the identity information of the session. The packets 242 and 244 may include the same information (e.g., this indicates that the external electronic device 220 has the identity information of the session), and may be transmitted according to a determined number of times so that the electronic device 210 is able to successfully receive the packet.

The electronic device 210 may, when at least one of the packets 242 and 244 indicating that the external electronic device 220 has the identity information of the session is successfully received, compare the identity information included in the packet 242 or 244 with the identity information possessed by the electronic device 210. When the identity information included in the packet 242 or 244 matches the identity information possessed by the electronic device 210, the electronic device 210 may transmit, to the external electronic device 220, a packet (confirm session ID) 251 indicating that the identity information of the session has been identified. The electronic device 210 may, after expiration of a designated time after the transmission of the packet 251 has completed, transmit, to the external electronic device 220, a packet 253 indicating that the electronic device 210 has identified the identity information of the session.

The external electronic device 220 may, when at least one of the packets 241 and 243 indicating that the electronic device 210 has the identity information of the session is successfully received, compare the identity information included in the packet 241 or 243 with the identity information possessed by the external electronic device 220. When the identity information included in the packet 241 or 243 matches the identity information possessed by the external electronic device 220, the external electronic device 220 may transmit, to the electronic device 210, a packet (confirm session ID) 252 indicating that the identity information of the session has been identified. The external electronic device 220 may, after expiration of a designated time after the transmission of the packet 252 has completed, transmit, to the electronic device 210, a packet 254 indicating that the external electronic device 220 has identified the identity information of the session.

The electronic device 210 may fail to receive the packets 252 and 254 indicating that the external electronic device 220 has identified the identity information of the session, according to various causes. When the electronic device 210 has failed to receive the packets 252 and 254 indicating that the external electronic device 220 has identified the identity information of the session, the electronic device 210 may be unable to transmit a packet 261 including information indicating whether the electronic device has a key used for encryption of data transmitted and/or received through the session.

The external electronic device 220 may, when at least one of the packets 251 and 253 indicating that the electronic device 210 has identified the identity information of the session is successfully received, transmit, to the electronic device 210, a packet 262 including information indicating whether the external electronic device 220 has a key used for encryption of data transmitted and/or received through the session. When the external electronic device 220 has the key, the external electronic device 220 may transmit, to the electronic device 210, the packet (has session key) 262 including information indicating that the external electronic device has the key. The external electronic device 220 may, after expiration of a designated time after the transmission of the packet 262 has completed, transmit, to the electronic device 210, a packet (has session key) 264 including information indicating that the external electronic device 220 has the key.

Even in a case where the electronic device 210 has failed to receive the packets 252 and 254 indicating that the external electronic device 220 has identified the identity information of the session, if reception of the packets (has session key) 262 and 264 including information indicating that the external electronic device 220 has the key is successful, the electronic device may transmit, to the external electronic device 220, the packet 261 including information indicating whether the electronic device 210 has a key used for encryption of data transmitted and/or received through the session. Through the method described above, even when the electronic device 210 has failed to receive the packet indicating that the external electronic device 220 has identified the identity information of the session, the electronic device transmits the packet (e.g., the packet 261 or 263 in FIG. 2B) for identifying whether the external electronic device 220 has the key, to the external electronic device 220 according to a determined number of times of transmission, so that configuration of a quantum-encrypted call may be performed.

When the electronic device 210 has the key, the electronic device 210 may transmit, to the external electronic device 220, the packet (has session key) 261 including information indicating that the electronic device has the key. The electronic device 210 may, after expiration of a designated time after the transmission of the packet 261 has completed, transmit, to the external electronic device 220, a packet (has session key) 263 including information indicating that the electronic device 210 has the key.

The electronic device 210 may, when at least one of the packets (has session key) 262 and 264 including the information indicating that the external electronic device 220 has the key is successfully received, identify whether the key included in the packet 262 or 264 matches the key possessed by the electronic device 210. The electronic device 210 may identify that the key included in the packet 262 or 264 matches the key possessed by the electronic device 210, and transmit a packet (confirm session key) 271 indicating that the key has been identified to the external electronic device 220. The electronic device 210 may, after expiration of a designated time after the transmission of the packet 271 has completed, transmit, to the external electronic device 220, a packet (confirm session key) 273 indicating that the key has been identified.

The external electronic device 220 may, when at least one of the packets (has session key) 261 and 263 including the information indicating that the electronic device 210 has the key is successfully received, identify whether the key included in the packet 261 or 263 matches the key possessed by the external electronic device 220. The external electronic device 220 may identify that the key included in the packet 261 or 263 matches the key possessed by the external electronic device 220, and transmit a packet (confirm session key) 272 indicating that the key has been identified to the electronic device 210. The external electronic device 220 may, after expiration of a designated time after the transmission of the packet 272 has completed, transmit a packet (confirm session key) 274 indicating that the key has been identified to the electronic device 210.

As in the method described above, the electronic device 210 and the external electronic device 220 may perform a procedure of identifying identity information of a session to be established between the electronic device 210 and the external electronic device 220 and a key transmitted and/or received through the session.

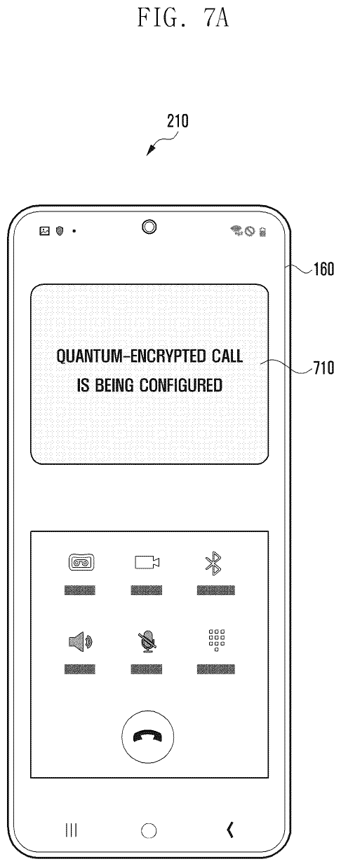

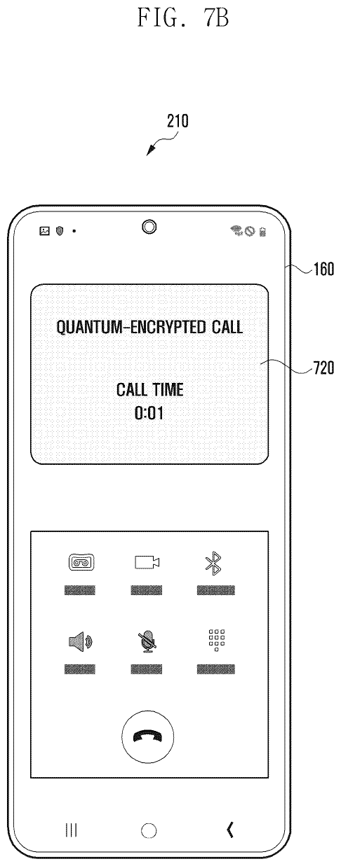

FIG. 7A and FIG. 7B are diagrams illustrating an example in which an electronic device outputs information indicating activation of a quantum-encrypted call according to various embodiments.

An electronic device (e.g., the electronic device 210 in FIG. 3) may provide a user with information indicating that a quantum-encrypted call is being configured, through various methods while configuring the quantum-encrypted call.

The electronic device 210 may display, on a display (e.g., the display module 160 in FIG. 1), information (or indicator) indicating that a quantum-encrypted call is being configured, while configuring the quantum-encrypted call. Referring to FIG. 7A, the electronic device 210 may display, on the display 160, information 710 indicating that a quantum-encrypted call is being configured.

The information indicating that a quantum-encrypted call is being configured may be provided to a user in various methods. FIG. 7A illustrates that information indicating that a quantum-encrypted call is being configured is output on a display, but the electronic device 210 may output a sound through a speaker (e.g., the speaker 441 in FIG. 5) as information indicating that a quantum-encrypted call is being configured. Alternatively, the electronic device 210 may output a vibration through a haptic module (e.g., the haptic module 179 in FIG. 1) as information indicating that a quantum-encrypted call is being configured.

According to completion of configuration of a quantum-encrypted call, the electronic device 210 may receive the user's speech through a microphone (e.g., the microphone 442 in FIG. 5) and perform quantum encryption of data corresponding to the speech. The electronic device 210 may transmit the encrypted data to an external electronic device (e.g., the external electronic device 220 in FIG. 2A).

The electronic device 210 may receive encrypted data transmitted by the external electronic device 220 and decrypt the encrypted data using a key. The decrypted data may be output through the speaker 441.

According to completion of configuration of a quantum-encrypted call (or while decrypted data is being output or while the quantum-encrypted call is being performed), the electronic device 210 may output information (or indicator) 720 indicating that configuration of the quantum-encrypted call is completed.

The information indicating that configuration of a quantum-encrypted call is completed may be provided to the user in various methods. FIG. 7B illustrates that the information 720 indicating that configuration of a quantum-encrypted call is completed is output on the display 160, but the electronic device 210 may output a sound through a speaker (e.g., the speaker 441 in FIG. 5) as information indicating that configuration of a quantum-encrypted call is completed. Alternatively, the electronic device 210 may output a vibration through a haptic module (e.g., the haptic module 179 in FIG. 1) as information indicating that configuration of a quantum-encrypted call is completed.

The information indicating that configuration of a quantum-encrypted call is completed may also be provided using text, but an indicator (or icon) indicating that configuration of a quantum-encrypted call is completed may be used to provide the information.

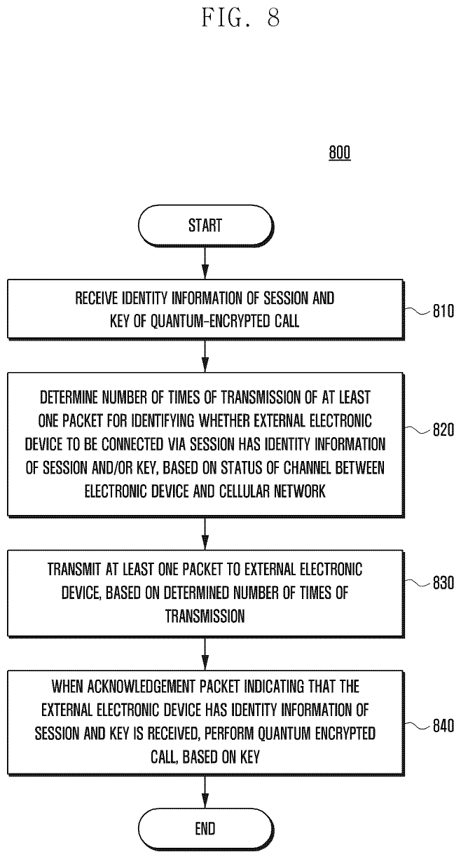

FIG. 8 is a flowchart illustrating an example method 800 of operating an electronic device according to various embodiments.

An electronic device (e.g., the electronic device 210 in FIG. 3) may, in operation 810, receive identity information of a session and a key of a quantum-encrypted call.

According to an example, the electronic device 210 may establish a session between the electronic device 210 and the external electronic device 220 according to the initiation of a call. The session may indicate a passage through which the electronic device 210 and/or the external electronic device 220 exchanges data related to the call.

The electronic device 210 may support a quantum-encrypted call. A quantum-encrypted call may be a call of a scheme of encrypting or decrypting packets (or data) transmitted and/or received during the call using a quantum password. Such a quantum-encrypted call is implemented in a scheme of exchanging encrypted packets (or data) using quantum mechanical characteristics to make eavesdropping or interception difficult and is thus highly regarded in terms of security. In a case where the cellular network 230 connected to the electronic device 210 and/or the external electronic device 220 support a quantum-encrypted call, the electronic device 210 may perform the quantum-encrypted call with the external electronic device 220.

The electronic device 210 may receive, according to initiation of a call, identity information of a session of a quantum-encrypted call and a key used in the quantum-encrypted call from the cellular network 230 supporting the quantum-encrypted call.

The identity information of the session and the key of the quantum-encrypted call may be stored in a quantum encryption server (e.g., the quantum encryption server 232 in FIG. 2A) of the cellular network 230. The electronic device 210 may request, from the quantum encryption server 232, information required for a quantum-encrypted call at the time of initiation of a call or before initiation of a call. The application processor 310 may receive identity information of a session and a key from the quantum encryption server 232.

A quantum-encrypted call may be activated when the electronic device 210 and the external electronic device 220 performing the quantum-encrypted call have the same identity information of a session and the same key. Therefore, the electronic device 210 may, before a quantum-encrypted call is activated, perform a series of operations of identifying whether the external electronic device 220 has the same identity information and the same key as the identity information of a session and the key possessed by the electronic device 210.

The electronic device 210 may transmit, to the external electronic device 220 a pre-designated number of times, a packet (e.g., the packet 241 or 243 in FIG. 2B) for identifying whether the external electronic device 220 has identity information of a session and/or a packet (e.g., the packet 261 or 263 in FIG. 2B) for identifying whether the external electronic device 220 has a key, so as to identify whether the external electronic device 220 has the same identity information and the same key as the identity information of the session and the key possessed by the electronic device 210.

The electronic device 210 may, in operation 820, determine the number of times of transmission of at least one packet for identifying whether an external electronic device (e.g., the external electronic device 220 in FIG. 2A) to be connected via the session has the identity information of the session and the key, based on a status of a channel between the electronic device 210 and the cellular network 230.

The electronic device 210 may determine (or adjust or change) the number of times of packet transmission, based on a status of a channel between the electronic device 210 and the cellular network 230.

According to an example, the electronic device 210 may determine the number of times of packet transmission, based on information (e.g., the loss rate of a packet) related to the loss of a packet received by the electronic device 210 from the cellular network 230 and/or information (e.g., the occurrence rate of jitter) related to the occurrence of jitter of a packet received by the electronic device 210 from the cellular network 230.

The greater the loss rate of the packet, the lower the probability that the external electronic device 220 receives at least one packet for identifying whether the external electronic device 220 has identity information of a session and a key. Therefore, as the loss rate of a packet becomes greater, the electronic device 210 may increase the number of times of transmission of at least one packet for identifying whether the external electronic device 220 has identity information of a session and a key.

According to an example, the electronic device 210 may determine the number of times of transmission of at least one packet for identifying whether the external electronic device 220 has identity information of a session and a key, by referring to mapping data in which the loss rate of a packet and the number of times of transmission are mapped.

For example, when the loss rate of a packet is included in a designated range (e.g., equal to or smaller than 1%), the electronic device 210 may determine (or configure) a first value (e.g., 2 times) as the number of times of transmission of at least one packet for identifying whether the external electronic device 220 has identity information of a session and a key.

For example, when the loss rate of a packet is included in a designated range (e.g., equal to or greater than 1% and equal to or smaller than 5%), the electronic device 210 may determine (or configure) a second value (e.g., 3 times) as the number of times of transmission of at least one packet for identifying whether the external electronic device 220 has identity information of a session and a key.

The greater the occurrence rate of jitter, the lower the probability that the external electronic device 220 receives at least one packet for identifying whether the external electronic device 220 has identity information of a session and a key. Therefore, as the occurrence rate of jitter becomes greater, the electronic device 210 may increase the number of times of transmission of at least one packet for identifying whether the external electronic device 220 has identity information of a session and a key.

According to an example, the electronic device 210 may determine the number of times of transmission of at least one packet for identifying whether the external electronic device 220 has identity information of a session and a key, by referring to mapping data in which the occurrence rate of jitter and the number of times of transmission are mapped.

For example, when the occurrence rate of jitter is included in a designated range (e.g., equal to or smaller than 1%), the electronic device 210 may determine (or configure) a first value (e.g., 2 times) as the number of times of transmission of at least one packet for identifying whether the external electronic device 220 has identity information of a session and a key.

For example, when the occurrence rate of jitter is included in a designated range (e.g., equal to or greater than 1% and equal to or smaller than 5%), the electronic device 210 may determine (or configure) a second value (e.g., 3 times) as the number of times of transmission of at least one packet for identifying whether the external electronic device 220 has identity information of a session and a key.

The electronic device 210 may also determine the number of times of transmission of at least one packet for identifying whether the external electronic device 220 has identity information of a session and a key, by considering both the loss rate of a packet and the occurrence rate of jitter.

According to an example, the electronic device 210 may determine the number of times of transmission of at least one packet for identifying whether the external electronic device 220 has identity information of a session and a key, by referring to mapping data in which the loss rate of a packet and the occurrence rate of jitter, and the number of times of transmission are mapped.

For example, when the occurrence rate of jitter is included in a designated range (e.g., equal to or smaller than 1%) and the loss rate of a packet is included in a designated range (e.g., equal to or smaller than 1%), the electronic device 210 may determine (or configure) a first value (e.g., 2 times) as the number of times of transmission of at least one packet for identifying whether the external electronic device 220 has identity information of a session and a key.

For example, when the occurrence rate of jitter is included in a designated range (e.g., equal to or greater than 10%) and the loss rate of a packet is included in a designated range (e.g., equal to or greater than 10%), the electronic device 210 may determine (or configure) a second value (e.g., 5 times) as the number of times of transmission of at least one packet for identifying whether the external electronic device 220 has identity information of a session and a key.

The example described above shows an example in which the electronic device 210 determines the number of times of transmission of at least one packet for identifying whether the external electronic device 220 has identity information of a session and a key, based on the occurrence rate of jitter and the loss rate of a packet. However, the disclosure may not be limited thereto.

According to an example, the electronic device 210 may determine the number of times of transmission of at least one packet for identifying whether the external electronic device 220 has identity information of a session and a key, by referring to information (e.g., an uplink grant or a downlink grant) related to resources allocated by the cellular network 230 to the electronic device 210. For example, as the resources allocated by the cellular network 230 to the electronic device 210 becomes larger, the electronic device 210 may configure less transmissions of at least one packet for identifying whether the external electronic device 220 has identity information of a session and a key. The larger the resources allocated by the cellular network 230 to the electronic device 210, the greater the probability that the external electronic device 220 receives at least one packet for identifying whether the external electronic device 220 has identity information of a session and a key.

According to an example, the electronic device 210 may determine the number of times of transmission of at least one packet for identifying whether the external electronic device 220 has identity information of a session and a key, by referring to an error rate (e.g., an uplink block error rate (BLER) or a downlink block error rate (BLER)) measured by the cellular network. For example, as the error rate measured by the cellular network becomes greater, the electronic device 210 may configure more transmissions of at least one packet for identifying whether the external electronic device 220 has identity information of a session and a key. The greater the error rate measured by the cellular network, the smaller the probability that the external electronic device 220 receives at least one packet for identifying whether the external electronic device 220 has identity information of a session and a key.

According to an example, the electronic device 210 may determine the number of times of transmission of at least one packet for identifying whether the external electronic device 220 has identity information of a session and a key, based on a quality (RSSI or RSRP) of a signal measured by the communication circuit 330. For example, as the quality of the signal measured by the communication circuit 330 becomes greater, the electronic device 210 may configure less transmissions of at least one packet for identifying whether the external electronic device 220 has identity information of a session and a key. The greater the quality of the signal measured by the communication circuit 330, the greater the probability that the external electronic device 220 receives at least one packet for identifying whether the external electronic device 220 has identity information of a session and a key.

The electronic device 210 may determine the number of times of transmission of at least one packet for identifying whether the external electronic device 220 has identity information of a session and a key, by considering both a status of a channel between the electronic device 210 and the cellular network 230 and a previously measured status of a channel between the electronic device 210 and the cellular network 230.

The electronic device 210 may also determine a transmission interval of at least one packet for identifying whether the external electronic device 220 has identity information of a session and a key, based on a status of a channel between the electronic device 210 and the cellular network 230. The better the status of the channel between the electronic device 210 and the cellular network 230, the application processor may configure, to be relatively short, the transmission interval of at least one packet for identifying whether the external electronic device 220 has identity information of a session and a key. On the contrary, the worse the status of the channel between the electronic device 210 and the cellular network 230, the application processor may configure, to be relatively long, the transmission interval of at least one packet for identifying whether the external electronic device 220 has identity information of a session and a key. When the status of the channel between the electronic device 210 and the cellular network 230 is bad and the transmission interval of at least one packet for identifying whether the external electronic device 220 has identity information of a session and a key is short, the congestion level of the channel may be increased.

The electronic device 210 may, in operation 830, transmit the at least one packet to the external electronic device 220, based on the determined number of times of transmission.

The electronic device 210 may transmit, to the external electronic device 220, the packet 241 indicating that the electronic device 210 has the identity information of the session. The electronic device 210 may, after expiration of a designated time after the transmission of the packet 241 has completed, transmit, to the external electronic device 220, the packet 243 indicating that the electronic device 210 has the identity information of the session. The packets 241 and 243 may include the same information (e.g., this indicates that the electronic device 210 has the identity information of the session), and may be transmitted according to a determined number of times so that the external electronic device 220 is able to successfully receive the packet.

The external electronic device 220 may transmit, to the electronic device 210, the packet 242 indicating that the external electronic device 220 has the identity information of the session. The external electronic device 220 may, after expiration of a designated time after the transmission of the packet 242 has completed, transmit, to the electronic device 210, the packet 244 indicating that the external electronic device 220 has the identity information of the session. The packets 242 and 244 may include the same information (e.g., this indicates that the external electronic device 220 has the identity information of the session), and may be transmitted according to a determined number of times so that the electronic device 210 is able to successfully receive the packet.

The electronic device 210 may, when at least one of the packets 242 and 244 indicating that the external electronic device 220 has the identity information of the session is successfully received, compare the identity information included in the packet 242 or 244 with the identity information possessed by the electronic device 210. When the identity information included in the packet 242 or 244 matches the identity information possessed by the electronic device 210, the electronic device 210 may transmit, to the external electronic device 220, the packet (confirm session ID) 251 indicating that the identity information of the session has been identified. The electronic device 210 may, after expiration of a designated time after the transmission of the packet 251 has completed, transmit, to the external electronic device 220, the packet 253 indicating that the electronic device 210 has identified the identity information of the session.

The external electronic device 220 may, when at least one of the packets 241 and 243 indicating that the electronic device 210 has the identity information of the session is successfully received, compare the identity information included in the packet 241 or 243 with the identity information possessed by the external electronic device 220. When the identity information included in the packet 241 or 243 matches the identity information possessed by the external electronic device 220, the external electronic device 220 may transmit, to the electronic device 210, the packet (confirm session ID) 252 indicating that the identity information of the session has been identified. The external electronic device 220 may, after expiration of a designated time after the transmission of the packet 252 has completed, transmit, to the electronic device 210, the packet 254 indicating that the external electronic device 220 has identified the identity information of the session.

The electronic device 210 may, when at least one of the packets 252 and 254 indicating that the external electronic device 220 has identified the identity information of the session is successfully received, transmit, to the external electronic device 220, the packet 261 including information indicating whether the electronic device 210 has a key used for encryption of data transmitted and/or received through the session. When the electronic device 210 has the key, the electronic device 210 may transmit, to the external electronic device 220, the packet (has session key) 261 including information indicating that the electronic device has the key. The electronic device 210 may, after expiration of a designated time after the transmission of the packet 261 has completed, transmit, to the external electronic device 220, the packet (has session key) 263 including information indicating that the electronic device 210 has the key.

The external electronic device 220 may, when at least one of the packets 251 and 253 indicating that the electronic device 210 has identified the identity information of the session is successfully received, transmit, to the electronic device 210, the packet 262 including information indicating whether the external electronic device 220 has a key used for encryption of data transmitted and/or received through the session. When the external electronic device 220 has the key, the external electronic device 220 may transmit, to the electronic device 210, the packet (has session key) 262 including information indicating that the external electronic device has the key. The external electronic device 220 may, after expiration of a designated time after the transmission of the packet 262 has completed, transmit, to the electronic device 210, the packet (has session key) 264 including information indicating that the external electronic device 220 has the key.

The electronic device 210 may, when at least one of the packets (has session key) 262 and 264 including the information indicating that the external electronic device 220 has the key is successfully received, identify whether the key included in the packet 262 or 264 matches the key possessed by the electronic device 210. The electronic device 210 may identify that the key included in the packet 262 or 264 matches the key possessed by the electronic device 210, and transmit a packet (confirm session key) 271 indicating that the key has been identified to the external electronic device 220. The electronic device 210 may, after expiration of a designated time after the transmission of the packet 271 has completed, transmit, to the external electronic device 220, the packet (confirm session key) 273 indicating that the key has been identified.

The external electronic device 220 may, when at least one of the packets (has session key) 261 and 263 including the information indicating that the electronic device 210 has the key is successfully received, identify whether the key included in the packet 261 or 263 matches the key possessed by the external electronic device 220. The external electronic device 220 may identify that the key included in the packet 261 or 263 matches the key possessed by the external electronic device 220, and transmit the packet (confirm session key) 272 indicating that the key has been identified to the electronic device 210. The external electronic device 220 may, after expiration of a designated time after the transmission of the packet 272 has completed, transmit the packet (confirm session key) 274 indicating that the key has been identified to the electronic device 210.

According to an example, the electronic device 210 may transmit a packet including both the identity information of the session and information indicating that the electronic device 210 has the key, to the external electronic device 220 according to a determined number of times of transmission so as to reduce the time taken to configure a quantum-encrypted call. The external electronic device 220 may also transmit, to the electronic device 210, a packet including both the identity information of the session and information indicating that the external electronic device 220 has the key. When the packet including both the identity information of the session and information indicating that the electronic device 210 has the key is received, the application processor 310 may identify whether the identity information of the session included in the packet matches the identity information possessed by the electronic device 210 and whether the key included in the packet matches the key possessed by the electronic device 210. The application processor 310 may transmit, to the external electronic device 220, a packet indicating that the identity information of the session and the key have been identified, based on that the identity information of the session included in the packet matches the identity information possessed by the electronic device 210 and the key included in the packet matches the key possessed by the electronic device 210.

The electronic device 210 may, in operation 840, when an acknowledgement packet indicating that the external electronic device has the identity information of the session and the key is received, perform the quantum encrypted call, based on the key.

The electronic device 210 may identify that the external electronic device 220 has the identity information of the session and the key, through the method described above, and activate the quantum-encrypted call. The electronic device 210 may transmit the identity information of the session and the key to the communication processor 320 according to the activation of the quantum-encrypted call. The electronic device 210 may output information (or indicator) indicating that the quantum-encrypted call is being configured, while activating the quantum-encrypted call.

The communication processor 320 may, according to the activation of the quantum-encrypted call, receive an external input including a user's speech through a microphone (e.g., the input module 150 in FIG. 1) operatively connected to the communication processor 320, and perform quantum encryption of data corresponding to the external input using the key. The communication processor 320 may transmit the encrypted data to the external electronic device 220 through a session.

The communication processor 320 may receive encrypted data from the external electronic device 220 and decrypt same using a key. The communication processor 320 may output a signal corresponding to the decrypted data through a speaker (e.g., the sound output module 155 in FIG. 1) operatively connected to the communication processor 320.

An electronic device (e.g., the electronic device 210 in FIG. 2A) according to an example embodiment may include a communication circuit (e.g., the communication circuit 330 in FIG. 3); an application processor (e.g., the application processor 310 in FIG. 3) including at least one processor, comprising processing circuitry; a communication processor (e.g., the communication processor 320 in FIG. 3) including at least one processor, comprising processing circuitry; wherein, at least one processor, individually and/or collectively, of the application processor may, be configured to: according to initiation of a call, receive, from a cellular network (e.g., the cellular network 230 in FIG. 2A) supporting a quantum encrypted call, identity information of a session of the quantum encrypted call and information indicating a key of the quantum encrypted call; determine a number of times of transmission of at least one packet for identifying whether the external electronic device to be connected via the session has the identity information of the session and/or the key, based on a status of a channel between the cellular network and the electronic device; control the electronic device to transmit the at least one packet to the external electronic device, based on the determined number of times of transmission; and based on the electronic device receiving, from the external electronic device, an acknowledgement packet indicating that the external electronic device has the identity information of the session and the key, perform the quantum encrypted call, based on the key.

In the electronic device according to an example, at least one processor, individually and/or collectively, of the application processor may be configured to transmit the identity information of the session and the key received from the external electronic device to the communication processor; and control the communication processor to encrypt a packet to be transmitted to the external electronic device, based on the key.

In the electronic device according to an example, at least one processor, individually and/or collectively, of the application processor may be configured to determine the number of times of transmission, based on a loss rate of at least one packet received by the electronic device from the cellular network and/or an occurrence rate of jitter for the at least one packet.

In the electronic device according to an example, at least one processor, individually and/or collectively, of the application processor may be configured to determine a transmission interval of at least one packet to be transmitted to the external electronic device, based on a loss rate of at least one packet received by the electronic device from the cellular network and/or an occurrence rate of jitter for the at least one packet.

In the electronic device according to an example, at least one processor, individually and/or collectively, of the application processor may be configured to determine the number of times of transmission of the at least one packet, based on the status of the channel and history information regarding the status of the channel between the cellular network and the electronic device.

In the electronic device according to an example, at least one processor, individually and/or collectively, of the application processor may transmit a first packet (e.g., the packet 241 or 243 in FIG. 2B) indicating that the electronic device has the identity information of the session to the external electronic device according to the determined number of times of transmission; based on the electronic device receiving a second packet (e.g., the packet 242 or 244 in FIG. 2B) indicating that the external electronic device has the identity information of the session, control the electronic device to transmit, to the external electronic device, a third packet (e.g., the packet 251 or 253 in FIG. 2B) indicating that the electronic device receives the identity information according to the determined number of times of transmission; based on the electronic device receiving a fourth packet (e.g., the packet 252 or 254 in FIG. 2B) indicating that the external electronic device receives the identity information, control the electronic device to transmit, to the external electronic device, a fifth packet (e.g., the packet 261 or 263 in FIG. 2B) indicating whether the electronic device has the key, according to the determined number of times of transmission; and based on the electronic device receiving a sixth packet (e.g., the packet 262 or 264 in FIG. 2B) indicating whether the external electronic device has the key, control the electronic device to transmit, to the external electronic device, a seventh packet (e.g., the packet 271 or 273 in FIG. 2B) indicating that the electronic device identifies that the external electronic device 220 has the key, according to the determined number of times of transmission.

In the electronic device according to an example, at least one processor, individually and/or collectively, of the application processor may be configured to, based on the electronic device not receiving the fourth packet and receiving the sixth packet during transmitting the third packet to the external electronic device according to the determined number of times of transmission, control the electronic device to transmit the fifth packet to the external electronic device.

In the electronic device according to an example, at least one processor, individually and/or collectively, of the application processor may be configured to control the electronic device to transmit, to the external electronic device, an eighth packet (e.g., the packet 511 or 513 in FIG. 5) indicating that the electronic device has the identity information of the session and the key according to the determined number of times of transmission; and based on the electronic device receiving a ninth packet (e.g., the packet 512 or 514 in FIG. 5) indicating that the external electronic device has the identity information of the session and the key, control the electronic device to transmit, to the external electronic device, a tenth packet (e.g., the packet 521 or 523 in FIG. 5) indicating that the electronic device identifies that the external electronic device has the identity information of the session and the key.

In the electronic device according to an example, at least one processor, individually and/or collectively, of the application processor may be configured to output information indicating that the quantum encrypted call is being configured, during transmitting, to the external electronic device, the at least one packet.

In the electronic device according to an example, the at least one packet may be configured to be transmitted via a user datagram protocol (UDP).

A method of operating the electronic device according to an example may include: receiving, according to initiation of a call and from the cellular network supporting a quantum encrypted call, identity information of a session of the quantum encrypted call and information indicating a key of the quantum encrypted call; determining the number of times of transmission of at least one packet for identifying whether the external electronic device to be connected via the session has the identity information of the session and/or the key, based on a status of a channel between the cellular network and the electronic device; transmitting the at least one packet to the external electronic device, based on the determined number of times of transmission; and based on the electronic device receiving, from the external electronic device, an acknowledgement packet indicating that the external electronic device has the identity information of the session and the key, performing the quantum encrypted call, based on the key.

The method of operating the electronic device according to an example may include: transmitting the identity information of the session and the key received from the external electronic device to the communication processor; and controlling the communication processor to encrypt a packet to be transmitted to the external electronic device, based on the key.

In the method of operating the electronic device according to an example, the determining of the number of times of transmission may include determining the number of times of transmission, based on a loss rate of at least one packet received by the electronic device from the cellular network and/or an occurrence rate of jitter for the at least one packet.

The method of operating the electronic device according to an example may further include determining a transmission interval of at least one packet to be transmitted to the external electronic device, based on a loss rate of at least one packet received by the electronic device from the cellular network and/or an occurrence rate of jitter for the at least one packet.

In the method of operating the electronic device according to an example, the determining of the number of times of transmission may include determining the number of times of transmission of the at least one packet, based on the status of the channel and history information regarding the status of the channel between the cellular network and the electronic device.

In the method of operating the electronic device according to an example, the transmitting of the at least one packet to the external electronic device may include: transmitting a first packet (e.g., the packet 241 or 243 in FIG. 2B) indicating that the electronic device has the identity information of the session to the external electronic device according to the determined number of times of transmission; and based on the electronic device receiving a second packet (e.g., the packet 242 or 244 in FIG. 2B) indicating that the external electronic device has the identity information of the session, transmitting, to the external electronic device, a third packet (e.g., the packet 251 or 253 in FIG. 2B) indicating that the electronic device receives the identity information according to the determined number of times of transmission. The transmitting of the at least one packet to the external electronic device may include, based on the electronic device receiving a fourth packet (e.g., the packet 252 or 254 in FIG. 2B) indicating that the external electronic device receives the identity information, transmitting, to the external electronic device, a fifth packet (e.g., the packet 261 or 263 in FIG. 2B) indicating whether the electronic device has the key, according to the determined number of times of transmission. The transmitting of the at least one packet to the external electronic device may include, based on the electronic device receiving a sixth packet (e.g., the packet 262 or 264 in FIG. 2B) indicating whether the external electronic device has the key, transmitting, to the external electronic device, a seventh packet (e.g., the packet 271 or 273 in FIG. 2B) indicating that the electronic device identifies that the external electronic device has the key, according to the determined number of times of transmission.

In the method of operating the electronic device according to an example, the transmitting of the at least one packet to the external electronic device may include transmitting an eighth packet (e.g., the packet 511 or 513 in FIG. 5) indicating that the electronic device has the identity information of the session and the key to the external electronic device according to the determined number of times of transmission. The transmitting of the at least one packet to the external electronic device may include, based on the electronic device receiving a ninth packet (e.g., the packet 512 or 514 in FIG. 5) indicating that the external electronic device has the identity information of the session and the key, transmitting, to the external electronic device, a tenth packet (e.g., the packet 521 or 523 in FIG. 5) indicating that the electronic device identifies that the external electronic device has the identity information of the session and the key.

The method of operating the electronic device according to an example may further include outputting information indicating that the quantum encrypted call is being configured, during transmitting, to the external electronic device, the at least one packet.

In the method of operating the electronic device according to an example, the at least one packet may be transmitted via a user datagram protocol (UDP).

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a communication circuit;
an application processor including at least one processor comprising processing circuitry; and
a communication processor including at least one processor comprising processing circuitry,
wherein at least one processor, individually and/or collectively, of the application processor is configured to:
according to initiation of a call, receive, from a cellular network supporting a quantum encrypted call, identity information of a session of the quantum encrypted call and information indicating a key of the quantum encrypted call;
determine a number of times of transmission of at least one packet for identifying whether an external electronic device to be connected via the session has the identity information of the session and/or the key, based on a status of a channel between the electronic device and the cellular network;
control the electronic device to transmit the at least one packet to the external electronic device, based on the determined number of times of transmission; and
based on the electronic device receiving, from the external electronic device, an acknowledgement packet indicating that the external electronic device has the identity information of the session and the key, perform the quantum encrypted call, based on the key.

2. The electronic device of claim 1, wherein at least one processor, individually and/or collectively, of the application processor is configured to:
transmit the identity information of the session and the key received from the external electronic device to the communication processor; and
control the communication processor to encrypt a packet to be transmitted to the external electronic device, based on the key.

3. The electronic device of claim 1, wherein at least one processor, individually and/or collectively, of the application processor is configured to determine the number of times of transmission, based on a loss rate of at least one packet received by the electronic device from the cellular network and/or an occurrence rate of jitter for the at least one packet.

4. The electronic device of claim 1, wherein at least one processor, individually and/or collectively, of the application processor is configured to determine a transmission interval of at least one packet to be transmitted to the external electronic device, based on a loss rate of at least one packet received by the electronic device from the cellular network and/or an occurrence rate of jitter for the at least one packet.

5. The electronic device of claim 1, wherein at least one processor, individually and/or collectively, of the application processor is configured to determine the number of times of transmission of the at least one packet, based on the status of the channel and history information regarding the status of the channel between the cellular network and the electronic device.

6. The electronic device of claim 1, wherein at least one processor, individually and/or collectively, of the application processor is configured to:
control the electronic device to transmit a first packet indicating that the electronic device has the identity information of the session to the external electronic device according to the determined number of times of transmission;
based on the electronic device receiving a second packet indicating that the external electronic device has the identity information of the session, control the electronic device to transmit, to the external electronic device, a third packet indicating that the electronic device receives the identity information according to the determined number of times of transmission;
based on the electronic device receiving a fourth packet indicating that the external electronic device receives the identity information, control the electronic device to transmit, to the external electronic device, a fifth packet indicating whether the electronic device has the key, according to the determined number of times of transmission; and
based on the electronic device receiving a sixth packet indicating whether the external electronic device has the key, control the electronic device to transmit, to the external electronic device, a seventh packet indicating that the electronic device identifies that the external electronic device has the key, according to the determined number of times of transmission.

7. The electronic device of claim 6, wherein at least one processor, individually and/or collectively, of the application processor is configured to, based on the electronic device not receiving the fourth packet and receiving the sixth packet during transmitting the third packet to the external electronic device according to the determined number of times of transmission, control the electronic device to transmit the fifth packet to the external electronic device.

8. The electronic device of claim 1, wherein at least one processor, individually and/or collectively, of the application processor is configured to:
control the electronic device to transmit, to the external electronic device, an eighth packet indicating that the electronic device has the identity information of the session and the key according to the determined number of times of transmission; and
based on the electronic device receiving a ninth packet indicating that the external electronic device has the identity information of the session and the key, control the electronic device to transmit, to the external electronic device, a tenth packet indicating that the electronic device identifies that the external electronic device has the identity information of the session and the key.

9. The electronic device of claim 1, wherein at least one processor, individually and/or collectively, of the application processor is configured to output information indicating that the quantum encrypted call is being configured, during transmitting, to the external electronic device, the at least one packet.

10. The electronic device of claim 1, wherein the at least one packet is transmitted via a user datagram protocol (UDP).

11. A method of operating an electronic device, the method comprising:
receiving, according to initiation of a call and from a cellular network supporting a quantum encrypted call, identity information of a session of the quantum encrypted call and information indicating a key of the quantum encrypted call;
determining a number of times of transmission of at least one packet for identifying whether an external electronic device to be connected via the session has the identity information of the session and/or the key, based on a status of a channel between the cellular network and the electronic device;
transmitting the at least one packet to the external electronic device, based on the determined number of times of transmission; and
based on the electronic device receiving, from the external electronic device, an acknowledgement packet indicating that the external electronic device has the identity information of the session and the key, performing the quantum encrypted call, based on the key.

12. The method of claim 11, further comprising:
transmitting the identity information of the session and the key received from the external electronic device to a communication processor; and
controlling the communication processor to encrypt a packet to be transmitted to the external electronic device, based on the key.

13. The method of claim 11, wherein the determining of the number of times of transmission comprises determining the number of times of transmission, based on a loss rate of at least one packet received by the electronic device from the cellular network and/or an occurrence rate of jitter for the at least one packet.

14. The method of claim 11, further comprising determining a transmission interval of at least one packet to be transmitted to the external electronic device, based on a loss rate of at least one packet received by the electronic device from the cellular network and/or an occurrence rate of jitter for the at least one packet.

15. The method of claim 11, wherein the determining of the number of times of transmission comprises determining the number of times of transmission of the at least one packet, based on the status of the channel and history information regarding the status of the channel between the cellular network and the electronic device.

16. The method of claim 11, wherein the transmitting of the at least one packet to the external electronic device comprises:
transmitting a first packet indicating that the electronic device has the identity information of the session to the external electronic device according to the determined number of times of transmission;
based on the electronic device receiving a second packet indicating that the external electronic device has the identity information of the session, transmitting, to the external electronic device, a third packet indicating that the electronic device receives the identity information according to the determined number of times of transmission;
based on the electronic device receiving a fourth packet indicating that the external electronic device receives the identity information, transmitting, to the external electronic device, a fifth packet indicating whether the electronic device has the key, according to the determined number of times of transmission; and
based on the electronic device receiving a sixth packet indicating whether the external electronic device has the key, transmitting, to the external electronic device, a seventh packet indicating that the electronic device identifies that the external electronic device has the key, according to the determined number of times of transmission.

17. The method of claim 16, wherein the transmitting of the at least one packet to the external electronic device comprises, based on the electronic device receiving the sixth packet during transmitting the third packet to the external electronic device according to the determined number of times of transmission, stopping transmitting the third packet and transmitting the fifth packet to the external electronic device.

18. The method of claim 11, wherein the transmitting of the at least one packet to the external electronic device comprises:
transmitting an eighth packet indicating that the electronic device has the identity information of the session and the key to the external electronic device according to the determined number of times of transmission; and
based on the electronic device receiving a ninth packet indicating that the external electronic device has the identity information of the session and the key, transmitting, to the external electronic device, a tenth packet indicating that the electronic device identifies that the external electronic device has the identity information of the session and the key.

19. The method of claim 11, further comprising outputting information indicating that the quantum encrypted call is being configured, during transmitting, to the external electronic device, the at least one packet.

20. The method of claim 11, wherein the at least one packet is transmitted via a user datagram protocol (UDP).
